(19) United States
(12) Patent Application Publication
(10) Pub. No.: US 2019/0355014 A1
(43) Pub. Date: Nov. 21, 2019

(54) PREDICTIVE ANALYTICS SYSTEM

(71) Applicant: Stephen C. GERBER, Dublin, CA (US)

(72) Inventor: Stephen C. GERBER, Dublin, CA (US)

(73) Assignee: AMBER SOLUTIONS, INC., Danville, CA (US)

(21) Appl. No.: 15/980,311

(22) Filed: May 15, 2018

(51) Int. Cl. G06Q 30/02

(52) U.S. Cl. CPC G06Q 30/0254

(57) ABSTRACT

The invention is a predictive analysis system. The predictive analysis system analyzes one or more sensed signals automatically to predict various sensor states, or otherwise generate one or more actionable predicted tasks. The system is comprised of one or more sensors and/or processors coupled to a network. Sensor signals may indicate safety or power conditions for urgent or emergency response, or device configuration such as a locked door or turned on coffee pot. A sensor array is installable in residential or commercial structures to sense residential or building real-time conditions or embodied in vehicle or remote application accessible for mobile sensing. Further, the predictive analysis system uses sensor states to predict the needs of proximate individuals and delivers targeted advertisements according to the needs of the individuals.

### FIELD OF INVENTION

The invention pertains generally to the field of automated analysis systems, and particularly to sensor-based systems that automatically analyze sensor data predictively.

### BACKGROUND OF INVENTION

Conventional data processing systems that process sensor data automatically are limited analytically, to the extent conventional systems merely automate real-time processing of actual sensor data, but fail to process or otherwise predictively analyze any future sensor data or other possible sensor conditions or measurements. Thus, there is a need for improved sensor-based analysis.

Additionally, the subfield of data processing systems for targeted advertising has shortcomings. These systems rely on audience demographic data to determine the best advertisement host for an advertisement. Further, data processing systems for targeted advertising over the internet relies on data obtained via a user's computer input such as an individual's search history, sites and pages visited, and internet purchase history. Thus, there is an additional need for improved sensor-based consumer need prediction.

### SUMMARY

The invention resides in predictive analysis systems. The predictive analysis system analyzes one or more sensed signals automatically to predict various future sensor states or otherwise generate one or more actionable predicted tasks, learning and adapting to the conditions in which it is placed—an advantage over conventional systems, which processes based on real-time sensor data. The system is comprised of one or more sensors and/or processors coupled to one or more networks. Sensor signals may indicate various sensed conditions, such as, safety or power conditions for urgent or emergency response, environmental conditions, sounds, users present, or device configuration such as a locked door or a turned-on coffee pot. One or more sensors are installable in residential or commercial structures to sense residential or building real-time conditions or embodied in vehicle or remote application accessible for mobile sensing. Alternatively, it is herein contemplated that the sensor apparatus may be installed in non-commercial and non-residential applications.

Optionally, the system may access a database containing data related to sensor states, a user interface, a controller, and a device, which may be reconfigured. Advantageously, the system may contain one or more personal identifier, allowing for an individually tailored sensor state predicting and device reconfiguring experience. Additionally, the system may notify users of a device malfunction, enabling the user to maintain the effective operation of the system.

Alternatively, the predictive analysis system may use sensor states to automatically predict tailored advertisements based on an individual or household's predicted needs. By providing data through sensor states that may have otherwise been unavailable, this system advantageously allows for an advertiser to more accurately tailor his/her product advertisement to individuals in ways which he was previously unable. Additionally, the individuals receive the benefit of receiving more relevant advertisements.

### BRIEF DESCRIPTION OF FIGURES

FIG. 1 is general block diagram illustrating one or more aspect of the present invention.

FIG. 2 illustrates a mobile device and user interface aspects of the present invention.

FIG. 3 illustrates an orthogonal side view off a user interface preferably mounted to a wall via a gang box, aspect of the present invention.

FIG. 4 illustrates a sensing chamber aspect of the present invention.

FIG. 5 illustrates representative method flow chart of automated steps according to one or more aspect of the invention.

FIG. 6 illustrates representative method flow chart of automated steps according to one or more aspect of the invention.

FIG. 7 illustrates representative method flow chart of steps according to one or more aspect of the invention.

### DETAILED DESCRIPTION

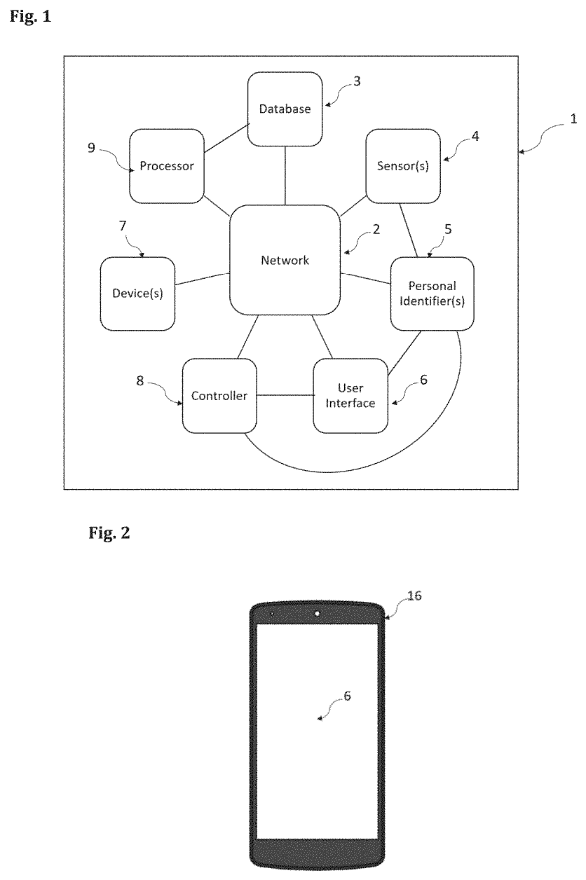

FIG. 1 block diagram shows the predictive analysis system 1, having one or more sensor 4 and a processor 9, coupled together via a network 2. Preferably, the network 2, is embodied in a Wi-Fi, Bluetooth, or other digital networking and data communications schemes, which enable data communication. The predictive analysis system 1, senses with one or more sensor 4, generating a signal, which is carried, over the network, to the processor 9, which processes the sensor signal automatically to predict a sensor state. A sensor 4 state is a sensor 4 sensing a condition, creating a signal reflecting the condition, i.e., its state.

It is contemplated herein that network 2, may be embodied in conventional and/or proprietary, wired and/or wireless hardware and/or software, integrated and/or modular means for sending and receiving digital data and/or electronic signals between processors, nodes or other addressable network sites coupled thereto. It is further contemplated herein that network 2, may be coupled to the world wide web or may be isolated as a network accessible only by the predictive analysis system 1. If connection over the web is not desired, it is preferable to isolate the network as accessible, via password or other mechanism, by only the predictive analysis system 1, because it enhances security and privacy by minimizing the risk of unauthorized access to sensor 4 state and device 7 configuration data, via vulnerabilities from other devices on the network 2.

Preferably, the predictive analysis system 1, also includes various additional components. Such as a database 3, a user interface 6, one or more device 7, a controller 8, and one or more personal identifier 5. The database 3 is coupled to the network 2, wherein data related to sensor 4 states is stored. Optionally, the database 3 contains data for multiple sensors 4 and includes data on the presence of one or more personal identifiers 5. The database 3 may be accessed by the processor 9 when predicting sensor 4 states. The user interface 6 is coupled to the network 2, enabling the user interface 6 to display the state of one or more sensors 4. The device 7 and the controller 8 are coupled to the network 2. Upon prediction of a sensor 4 state, by the processor 9, the controller 8 may reconfigure the device 7. The personal identifier 5, is coupled to the network 2 or alternatively sensed by a sensor 4. The presence of the personal identifier 5, preferably, allows the predictive analysis system 1 to predict sensor 4 states in light of the personal identifier's 5 presence or absence, enabling an individually tailored experience.

A device 7 is an appliance or other object with multiple configurations, such as, on and off, open and closed, high and low, etc. It is contemplated herein that the device 7 may be embodied in a door, a window, a lock, a light, a coffee maker, a shower, a pet food dispenser, a humidifier, a de-humidifier, a circuit breaker, a thermostat, a hot water heater, a furnace, an air conditioner, a water sprinkler, a water faucet, a water heater, a sump-pump, a fireplace, a well pump, a refrigerator, a freezer, a television, a garage door, or a water pipe flow valve.

A personal identifier 5, is an item that may be used to identify a specific user, usually carried on or about their person. It is contemplated herein that the personal identifier 5 may be embodied in a smartphone; tablet; or wearable, such as a Fit Bit or smartwatch. Additionally, it is further contemplated herein that the personal identification may be conducted through other means such as a biometric, such as facial recognition. Alternatively, it is further contemplated herein that the personal identification may be conducted by selection of an individual profile on the user interface 6.

In accordance with the present invention, database 3, is enabled through software and/or other functionally equivalent firmware, hardware, or electronics, for storing, accessing, and distributing information. Additionally, In accordance with the present invention, the processor 9, which processes the sensor 4 signal automatically to predict a sensor 4 state, is enabled through software and/or other functionally equivalent firmware, hardware, or electronics, for processing data and digitally performing tasks. Further, prediction is enabled through smart computing such as artificial, deep learning, forward chaining, inductive reasoning, and machine learning. In this smart computing, accesses data from the past, such as a device's 7 configuration over time. This data is then analyzed with software, such as an algorithm, to identify patterns. For example, analysis may provide that a device 7 is usually in a certain configuration at a certain time. An embodiment of this is the processor 9, through a sensor 4 state, recognizing that a device such as a door lock, is configured in the locked position almost always at 9 p.m. or after a car leaves the garage; the processor 9 accordingly predicts a sensor 4 to be in a state reflecting the engagement of the door's lock at 9 p.m. in the future. This prediction enables actionable insights, such as how to configure a device 7.

FIG. 2 shows a mobile device 16 where a user interface 6 may be displayed and/or interacted with. Preferably, the mobile device 16 is embodied in a smartphone, tablet, smartwatch, or other personal portable device. Further, the user interface 6 is preferably displayed via an app, program, client, or other software program.

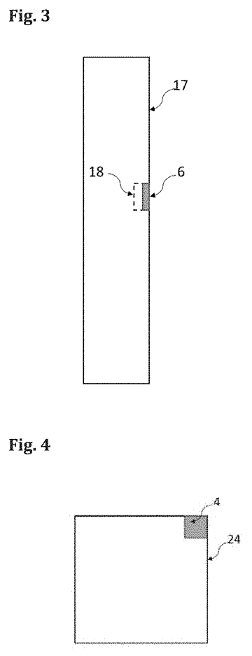

FIG. 3 orthogonal side view illustrates a user interface 6 mounted to a wall 17. Preferably, the user interface 6 is mounted into the wall 17 via a standard size gang box 18. A gang box, also known in the industry as an outlet box, is set into a wall and houses electrical componentry. Gang boxes are commonly available in standard sizes reflecting the number of components it can accommodate. A 1-gang box hosts a single component, a 2-gang box hosts two components, and so on. Preferably, if the user interface 6 or other componentry of the system is mounted into the wall 17 via the gang box 18, it will couple to one of these standard size gang boxes. Mounting into the wall via a gang box not only provides a standard readily available hook up, but provides for a readily available power source via wires in the wall and eliminates the need for batteries or a power outlet. Further, it eliminates wires or cables from view.

FIG. 4 shows a sensing chamber 24 wherein a sensor 4 is positioned. Additionally, it is herein contemplated that a controller 8 and network 2 may also be positioned in the sensing chamber 24. The sensing chamber better enables the sensing of conditions, such as, mold, humidity, water, particulates, or pests. It is contemplated herein that the sensing chamber may be inserted into a wall. It is further contemplated herein that the sensing chamber 24 may be a gang box 18. It is further yet contemplated that a cavity in a wall may itself serve as the sensing chamber 24 into which the sensor 4 is placed.

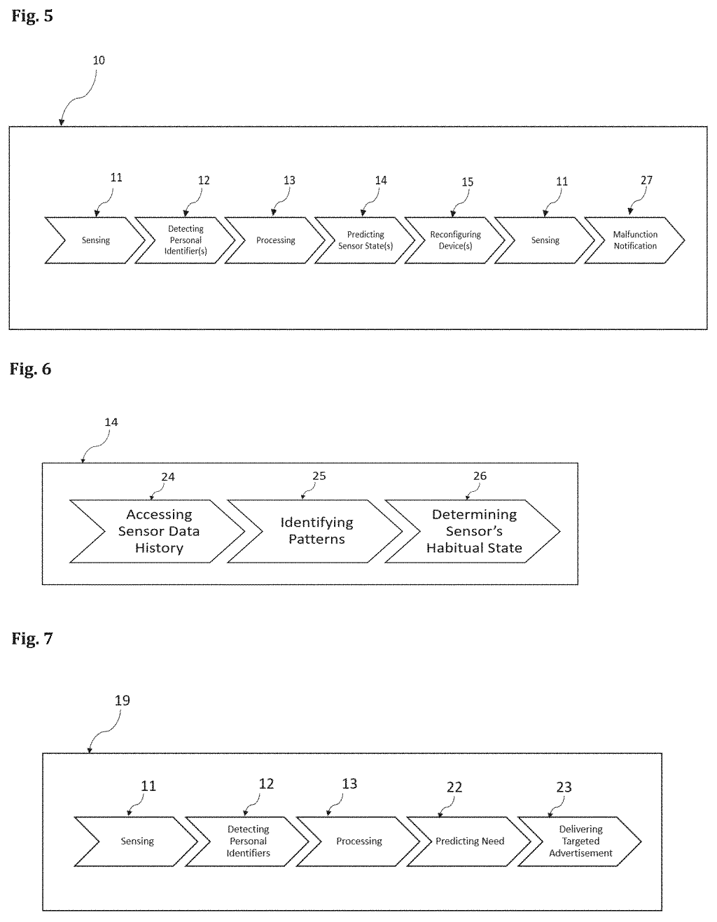

FIG. 5 method flow chart illustrates the automated steps according to one or more aspect of a predictive analysis method 10, having the steps of sensing 11, processing 13, and predicting one or more sensor state 14. In step 11, one or more sensor 4 senses and generates a signal. In step 13, a processor 9 processes the signal generated in step 11. Upon processing the signal, in step 13, the method predicts one or more sensor state. FIG. 5 also illustrates the optional, but preferable, additional steps of 12 detecting one or more personal identifier and 13 reconfiguring one or more device. With the additional step 12, the method detects a personal identifier 5, enabling the sensor state prediction 14 to reflect the additional data of the personal identifier's 5 presence. Further, with the additional step of 15, the method reconfigures a device 7 in accordance with the predicted sensor state. For example, sensing 11 a device's 7 configuration, such as a door's lock, the apparatus may process 13 and recognize that the lock is configured in the locked position almost always at 9 p.m. or after a car leaves the garage; the processor 9 accordingly predicts 14 the sensor to be in a state reflecting the engagement of the door's lock. If the door is not locked at 9 p.m. or after a car leaves the garage, the apparatus may then reconfigure 15 the door's lock in accordance with the predicted sensor state.

FIG. 5 method flow chart also illustrates the optional additional automated step of device 7 malfunction notification 27. The system 1, may be used to notify a user of a device 7 malfunction. The system's 1 sensor 4 may sense 11 a device to be in a certain configuration. Accordingly, the system 1 may predict 14 a sensor 4 state reflecting the device 7 as being configured to the on state. The system 1 may then reconfigure 15 the device's 7 configuration if it does not reflect the predicted state. Further, if after attempted reconfiguration 15, the sensor 4 does not sense 11 the device 7 being so configured, it can notify the user of the device's 7 malfunction. The system can notify the user of the device's 7 malfunction via a an email, an audible from a speaker located proximate to the targeted individual or group, a text, a user interface 6.

FIG. 6 method flow chart illustrates the automated steps according to one or more aspect of the predicting sensor state step 14. The predicting step 14 uses smart computing such as artificial, deep learning, forward chaining, inductive reasoning, and machine learning, which publicly available specifications are hereby referenced as appropriate. This smart computing is represented as, accessing sensor state data history 24, identifying patterns 25 though analysis with software, such as an algorithm, and determining the sensor's state 26 in accordance with the identified data pattern.

It is herein contemplated that the following non-exhaustive additional examples embody the predictive analysis system 1. The system 1 may sense 11 and recognize that a faucet is left running rarely for more than a certain length of time; the system may then predict 14 that the sensor 4 should reflect an off configuration of the faucet and reconfigure 15 the faucet accordingly after the length of time. This enables the system to prevent a faucet from being left on, wasting water. The system may undergo the same process for a stove, open door, open garage door, running toilet, running television, or other appliance. Alternatively, this enables the system to notify the user of the device's 7 configuration not reflecting its predicted state via the user interface 6, or other method such as an audible alert. Alternatively, instead of predicting 14 based on length of time for a sensor state, the system 1 may also predict for these sensor 4 states based on the time of day or other condition.

They system 1, may also be used to increase HVAC efficiency. The system's 1 sensors 4 may sense 11 that when an HVAC appliance, such as the air conditioning is running, it also almost always senses 11 that a device 7 is configured a certain way, such as windows closed; accordingly, the system 1 predicts 14 all windows to be closed when the air conduiting is running. This allows the system 1 to reconfigure 15 the windows, when the air conditioning is running, to the closed configuration, if they are not already closed, to reflect the predicted 14 state. Alternatively, this enables the system to notify the user of the device's 7 configuration not reflecting its predicted state. Notification may occur via an email, an audible from a speaker located proximate to the targeted individual or group, a text, or a user interface 6. Additionally, the system 1 may be used to increase HVAC efficiency by sensing 11 outside weather conditions, such as temperature or sunlight, and predict sensor 4 states inside a building according to these weather conditions. These predicted states enable the system 1 to reconfigure the HVAC device accordingly.

The system 1, may also be used to coordinate and reconfigure 15 windows according to wind direction. The system's 1 sensors 4 may sense 11 a wind direction outside a building and sense 11 air flow inside a building. Accordingly, the system 1 may predict 15 sensor 4 states reflecting one or more window configurations that achieve the highest air flow in accordance with the sensed wind direction. The system 1 may then reconfigure 15 the windows if their configuration does not reflect the predicted state.

The system 1, may also be used to trigger exhaust fan or mirror defogger. The system's 1 sensors 4 may sense 11 a shower being turned on or high levels of humidity. The system may then predict the running of an exhaust fan or mirror defogger during these sensed conditions and reconfigure 15 the exhaust fan for mirror defogger to the on configuration, if not already configured as such in accordance with its predicted configuration. Alternatively, the system 1 may predict the on configuration of an exhaust fan upon sensing chemicals or other air contaminant.

The system 1, may also be used to automatically control a shade. The system's 1 sensors 4 may sense 11 a condition such as light levels, temperature, or television configuration, and predict 14 a sensor 4 state reflecting a shade's configuration. The system 1 may then reconfigure 15 the shade if its configuration does not reflect the predicted state.

The system 1, may also be used to reconfigure 15 a language translator. The system's 1 sensors 4 may sense 11 spoken words in another language. Accordingly, the system 1 may predict 15 a sensor 4 state reflecting a language translator's configuration, when the foreign words are sensed. The system 1 may then reconfigure 15 the language translator if its configuration does not reflect the predicted state.

The system 1, may also be used to reconfigure 15 a garage door. The system's 1 sensors 4 may sense 11 a sound signature, such as that coming from a certain car. Accordingly, the system 1 may predict 15 a sensor 4 state reflecting a garage door's configuration. The system 1 may then reconfigure 15 the garage door if its configuration does not reflect the predicted state.

The system 1, may also be used to notify a user of a suspicious package, such as a potential bomb. The system's 1 sensors 4 may sense 11 the presence of an object such as a package at a location, such as a front porch. Additionally, the system 1 may also sense a condition such as a knocking of a door, a ring of a door bell, or a time of day. Accordingly, the system 1 may predict 15 sensor 4 states reflecting the knocking of the door, the ring of a door bell, or the time of day, to be substantially concurrent with the initial sensing of the object. The system 1 may then notify the user of the object's presence under abnormal or suspicious conditions according to its non-conformance with the system's 1 predicted sensor 4 states.

The system 1, may also be used to reconfigure 15 a mosquito repellant device. The system's 1 sensors 4 may sense 11 a sound signature, such as that coming from a mosquito. Accordingly, the system 1 may predict 15 a sensor 4 state reflecting a mosquito repellant device's configuration, when the sound signature is present. The system 1 may then reconfigure 15 the mosquito repellant device's configuration if it does not reflect the predicted state.

The system 1, may also be used to reconfigure 15 an alert device. The system's 1 sensors 4 may sense 11 a visitor at the front door through a condition such as the ring of a doorbell or the pressing of the doorbell button. Accordingly, the system 1 may predict 15 a sensor 4 state reflecting a door's configuration to the open position shortly thereafter. The system 1 may then reconfigure 15 the alert device if the predicted sensor 4 state does not occur within a time period after sensing the visitor's presence.

FIG. 7 method flow chart illustrates the automated steps according to one or more aspect of a predictive need advertising method 19, having the steps of sensing 11, processing 13, predicting need 22, and delivering a targeted advertisement 23 based on the predicted need. In step 11, one or more sensor 4 senses and generates a signal. In step 13, a processor 9 processes the signal generated in step 11. Upon processing the signal, in step 13, the method predicts a need 22 of an individual, a household, an organization, or any other entity to which the sensor 4 is proximately sensing. FIG. 7 also illustrates the optional, but preferable, additional steps of 12 detecting one or more personal identifier. With the additional step 12, the method detects a personal identifier 5, enabling the need prediction 14 to reflect the additional data of the personal identifier's 5 presence and thus the needs of the individual associated with the personal identifier. Further, with the additional step of 22, the method is enabled to deliver a targeted advertisement 23, to the individual user based on his/her individual need. In summary, the sensing 11, ultimately causes a targeted advertisement to be delivered 23, in accordance with an individual or groups predicted need 22.

The predicting need step 22 is enabled by machine learning, which publicly available specifications are hereby referenced as appropriate. For example, under machine learning, a computer is taught that certain sensed parameters represent certain things, such as a particular sound profile representing a specific game console. The computer is further programed to associate the sensed parameter with a need. For example, the sound profile of a specific game console means games for the specific game console are likely needed. Accordingly, the machine learns to associate sensed parameters with a need.

It is contemplated that the following examples illustrate the sensing 11 and need prediction 22 aspects of the predictive need advertising method of FIG. 7. A sensor 4 may detect the use of a drip coffee maker; the system 1 may then determine that the individual has a need for coffee filters, coffee grounds, or a new coffee maker. A sensor 4 may detect a water flow, a leak, or a toilet that runs too long; the system 1 may then determine that the individual has a need for a plumber. A sensor 4 may detect poor air flow or temperature control; the system 1 may then determine that the individual has a need for a HVAC (heating, ventilation, and air conditioning) professional. A sensor 4 may detect the movement of furniture; the system 1 may then determine that the individual is moving and has a need for a quick easy meal such as pizza. A sensor 4 may sense the blowing of a nose, coughing, or other indication of illness; the system 1 may then determine that the individual has an illness and thus has a need for cold supplies such as facial tissue, throat lozenges, or medication. A sensor 4 may detect the start of a gaming system such as an Xbox or PlayStation; the system 1 may then determine that the individual has a need for video games of a certain platform. Further, a sensor 4 may detect extensive shooting or vehicle driving while the individual plays on their gaming platform; the system may then determine a need for specific game genres such as shooting and racing, respectively, on the individuals specific gaming platform.

Further, it is contemplated herein that the step of delivering targeted advertisement 23 may be conducted through a variety of mediums, such as, an email, an audible from a speaker located proximate to the targeted individual or group, a text, a user interface 6, or traditional mail.

The foregoing descriptions of specific embodiments of the invention have been presented for purposes of illustration and description. They are not intended to be exhaustive or to limit the invention to the precise forms disclosed. Modifications and variations are possible in light of the above teaching. The embodiments were chosen and described in order to explain the principles and the application of the invention, thereby enabling others skilled in the art to utilize the invention in its various embodiments and modifications according to the particular purpose contemplated. The scope of the invention is intended to be defined by the claims appended hereto and their equivalents.

The invention claimed is:

1. A predictive analysis system comprising:
one or more sensor that generates one or more sensor signals; and
a processor that processes the sensor signal(s) automatically to analyze one or more predicted sensor state(s).

2. The system of claim 1 wherein the sensor and processor are integrated in a network for accessing a database.

3. The system of claim 1 wherein the sensor signal indicates a safety or power condition.

4. The system of claim 1 further comprising:
a controller;
wherein the controller reconfigures a device according to the predicted sensor state.

5. The system of claim 4 further comprising a user interface.

6. The system of claim 5 wherein the user interface receives the signal and displays the sensor's state.

7. The system of claim 5 wherein the user interface is mounted to a wall.

8. The system of claim 5 wherein the user interface is mounted into the wall via a standard gang box.

9. The system of claim 5 wherein the user interface is displayed on a mobile device.

10. The system of claim 1 wherein the sensor is placed inside a sensing chamber.

11. The system of claim 4 further comprising;
a personal identifier; and
wherein the predicted sensor state takes into account the presence of the personal identifier.

12. The system of claim 11 further comprising a user interface, whereby the user interface allows for reconfiguration to private mode, where the system no longer detects the personal identifier.

13. The system of claim 1, further comprising:
a wireless network exclusively accessed by the predictive analysis system, whereby components of the system communicates over this network;

14. The system of claim 4 wherein the system notifies a user of a device's malfunction.

15. A predictive analysis method comprising steps:
generating a sensor signal by a sensor; and
processing the sensor signal by a processor automatically to analyze a predicted sensor state.

16. The method of claim 15 further comprising the step of reconfiguring a device according to the predicted sensor state.

17. The method of claim 16 further comprising the step of:
detecting a personal identifier, and
predicting sensor state taking into account the presence of the personal identifier.

18. The method of claim 14 wherein the sensor comprises a plurality of sensors, installable in a residential or commercial building.

19. A predictive analysis method comprising the steps of:
sensing with a sensor;
generating a sensor signal by a sensor;
predicting an individual's or a group's need based on the sensor signal; and
delivering a targeted advertisement reflecting the predicted need.

20. The method of claim 19, further comprising the step of detecting a personal identifier.
